(19) United States
(12) Patent Application Publication
(10) Pub. No.: US 2008/0281739 A1
(43) Pub. Date: Nov. 13, 2008

(54) Automated administration of endowments throughout their life cycle

(76) Inventors: Kevin Byrne, Austin, TX (US); Ian Christopher, Austin, TX (US); Lora Zarbock, Austin, TX (US)

Correspondence Address: HAMILTON & TERRILE, LLP, P.O. BOX 203518, AUSTIN, TX, 78720, US

(21) Appl. No.: 11/746,100

(22) Filed: May 9, 2007

(51) Int. Cl. G06Q 40/00

(52) U.S. Cl. 705/35

(57) ABSTRACT

A method, system and program are disclosed for the automated administration of a plurality of endowments throughout their life cycles, comprised of life cycle phases which include: requisition, qualification, authorization, provision, obligation, termination, and end of life. Endowment objectives, constraints, resources, and results are similarly administered. An on-line request is made for an endowment, which is automatically transitioned from one life cycle phase to another once predetermined criteria have been met. Transition through each of the endowment's life cycle phases is further bounded by predetermined endowment objectives, constraints, resources, and results.

### BACKGROUND OF THE INVENTION

1. Field of the Invention

The present invention relates in general to the field of information handling systems and more specifically, to the automated administration of endowments.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The administration of business operations and processes continues to grow in complexity. Endowments are no exception, and performing due diligence, managing resources and budgets, making investments, monitoring deliverables, attaining objectives, and complying with internal policies and regulatory guidelines are ongoing challenges. Furthermore, endowments require ongoing administration throughout their life cycles. Sometimes the life cycles are short, involving a small, one-time grant. Others can be complex, representing millions of dollars in investments over many years and involving hundreds of global participants. Regardless of their size or complexity, endowment administration is now requiring increased efforts and traditional paper-based systems are proving to be inadequate.

It has become common in other sectors for corporations and even small businesses to automate their day-to-day operations. Procurement, supply chain management, requisitioning, fulfillment, asset management, disbursement, and customer self-service are just a few of the many business functions and processes that have been automated in recent years. Furthermore, the advent of the Internet and other networking technologies has facilitated end-user access to many of these, which has broadened not only their appeal, but their economic impact as well.

However, many of these current approaches are point solutions and as such, do not deliver the comprehensive and integrated answer to today's business needs. Other approaches may provide a high degree of business process integration, but generally do not incorporate life cycle concepts. As a result, no current solution exists for automating the administration of an endowment throughout its life cycle.

### SUMMARY OF THE INVENTION

A method, system and computer-usable medium embodying computer program code are disclosed for the automated administration of a plurality of endowments throughout their life cycles, which are comprised of life cycle phases. Endowment life cycle phases include, but are not limited to, requisition, qualification, authorization, provision, obligation, termination, and end of life. The endowment life cycle administration system similarly administers endowment objectives, constraints, resources, and results.

The requisition life cycle phase is bounded by the qualification life cycle phase, which is further bounded by endowment constraints and objectives. In one embodiment, an on-line request for an endowment is received, which initiates the requisition life cycle phase. Once the on-line endowment request is completed, it is transitioned to the qualification life cycle phase, which is bounded by predetermined endowment objectives and constraints. If the endowment request is within the predetermined bounds, it is automatically transitioned to the authorization life cycle phase, which is likewise bounded by endowment constraints. In one embodiment, if the qualified endowment request is within endowment constraints and meets other predetermined authorization criteria, it is automatically authorized. In another embodiment, a qualified endowment request is automatically routed for review. Once reviewed, the qualified endowment request is either authorized or declined.

An authorized endowment is then transitioned to the provisioning life cycle phase for fulfillment, which is accomplished by assigning or transferring endowment resources to the endowment. Endowment resources may include, but are not limited to, financial resources (e.g., monetary funds, line of credit, etc.), physical assets (e.g., laboratory equipment, computers, etc.), personnel (e.g., internal endowment sponsors, research personnel, etc.) and physical facilities (e.g., laboratory space). Provisioning of an authorized endowment request is bounded by endowment constraints and resources. Once the initial provisioning of an endowment request has been completed, it is transitioned to the obligation life cycle phase. Endowment obligations are the results (e.g., concluded research, reports delivered, studies completed, etc.) the endowment recipient delivers in exchange for the provision of the endowment. The obligation phase is bounded by the endowment results and resources, which are in turn bounded by the endowment constraints. Once endowment obligations have been fulfilled, the endowment is transitioned to the termination life cycle phase. Final results are delivered and archived, and renewable or durable endowment resources (e.g., assigned personnel, physical facilities, etc.) can be released for assignment to other endowments. The endowment is then signified as having reached the end of its life cycle.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that is used to implement the system and method of the present invention;

FIG. 2 is a generalized illustration of the operational components of an automated endowment administration system as implemented in accordance with an embodiment of the invention;

FIG. 3 is a simplified flow chart illustrating the life cycle phases of an endowment as implemented in accordance with an embodiment of the invention;

FIG. 4 is a generalized block diagram of an automated endowment life cycle administration system as implemented in accordance with an embodiment of the invention;

FIG. 5 is a simplified block diagram of the architecture of an automated endowment life cycle administration system as implemented in accordance with an embodiment of the invention; and

FIGS. 6a-e, generally referred to as FIG. 6, is a generalized flow chart of the operation of an automated endowment life cycle management system as implemented in accordance with an embodiment of the invention.

### DETAILED DESCRIPTION

A method, system and computer-usable medium embodying program code are disclosed for the automated administration of a plurality of endowments throughout their life cycles, which are comprised of life cycle phases. Endowment life cycle phases include, but are not limited to, requisition, qualification, authorization, provision, obligation, termination, and end of life. The endowment life cycle administration system similarly administers endowment objectives, constraints, resources, and results.

In one embodiment, an on-line request for an endowment is received and a life-cycle phase is initiated. Once the on-line endowment request is completed, it is transitioned to the qualification life cycle phase. If the endowment request is within the predetermined bounds, it is automatically transitioned to the authorization life cycle phase. A qualified endowment that meets predetermined authorization criteria is then automatically routed for review. Once reviewed, the qualified endowment request is either authorized or declined.

An authorized endowment is then transitioned to the provisioning life cycle phase for the assignment or transfer of resources to the endowment recipient. Once the initial provisioning of an endowment request has been completed, it is transitioned to the obligation life cycle phase. Endowment obligations are the results the endowment recipient delivers in exchange for the provision of the endowment. Once endowment obligations have been fulfilled, the endowment is transitioned to the termination life cycle phase. Final results are delivered and archived, and the endowment is then signified as having reached the end of its life cycle.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

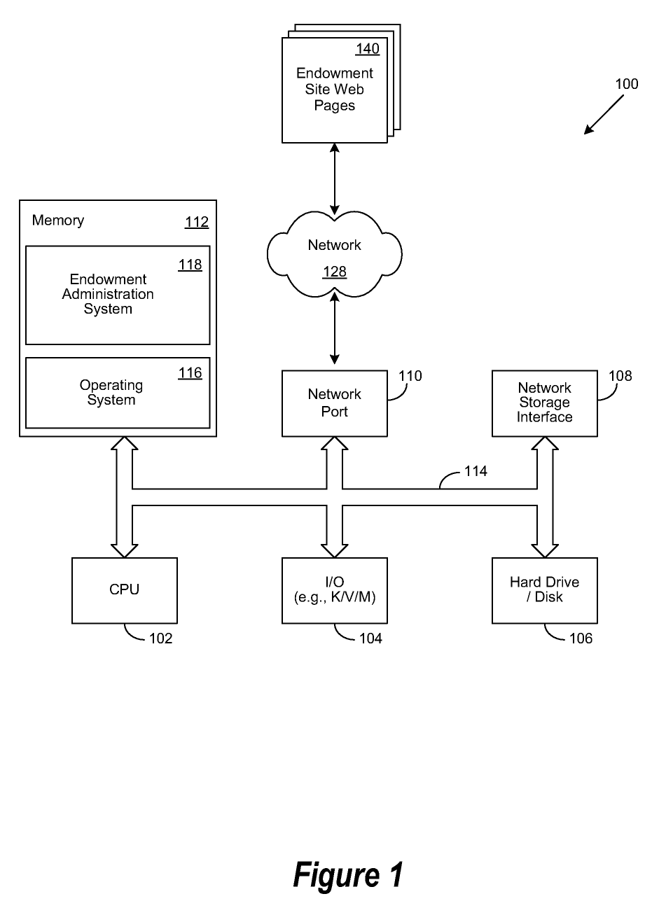

FIG. 1 is a generalized illustration of an information handling system 100 that can be used to implement the system and method of the present invention. The information handling system includes a processor (e.g., central processor unit or “CPU”) 102, input/output (I/O) devices 104, such as a display, a keyboard, a mouse, and associated controllers, a hard drive or disk storage 106, various other subsystems 108, network port 110 operable to connect to a network 128 to provide user access to the endowment site web pages 140, and system memory 112, all interconnected via one or more buses 114. System memory 112 further comprises operating system 116 and endowment administration system 118.

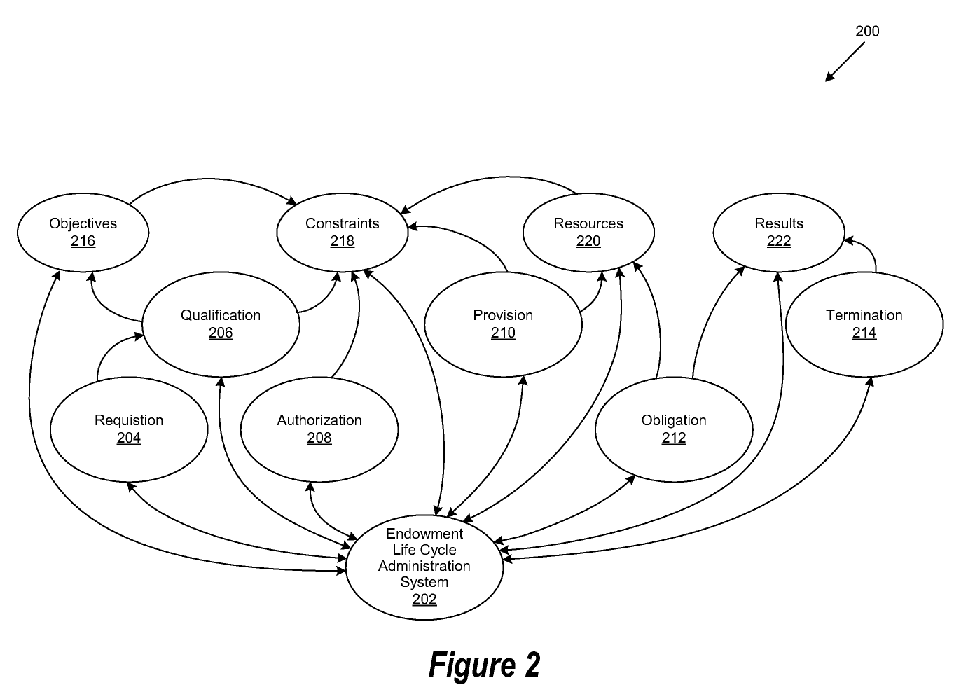

FIG. 2 is a generalized illustration of the operational components of an automated endowment administration system 200 as implemented in accordance with an embodiment of the invention. In this and other embodiments, the administration of a plurality of endowments is automated throughout their life cycles, which are comprised of life cycle phases. Endowment life cycle phases include, but are not limited to, requisition 204, qualification 206, authorization 208, provision 210, obligation 212 and termination 214, all of which are automatically administered by endowment life cycle administration system 202. The endowment life cycle administration system 202 similarly administers endowment objectives 216, endowment constraints 218, endowment resources 220, and endowment results 222.

The endowment requisition 204 life cycle phase is bounded by the qualification life cycle phase 206, which is further bounded by endowment constraints 218 and endowment objectives 216, which is likewise bounded by endowment constraints 218. For example, the receipt of an on-line request for an endowment, such as a grant or a scholarship, initiates the endowment requisition life cycle phase 204. Once the on-line endowment request is completed, it requires qualification, which results in the request being transitioned to the endowment qualification life cycle phase 206. The qualification of the endowment request is bounded by whether the purpose or use of the endowment request is within the bounds of predetermined endowment objectives 216 and does not exceed predetermined endowment constraints 218. If the endowment request is within the bounds of endowment objectives 216 (e.g., medical research grants) but exceeds one or more predetermined constraints (e.g., the requested dollar amount exceeds the financial grant limit), then the endowment request is disqualified. As another example, the endowment request may be within the bounds of endowment objectives 216, such as requesting a medical research grant for curing cancer. Furthermore, the endowment request may be for a dollar amount that is within the financial limit of endowment constraints 218. However, if the endowment request is for curing breast cancer in women and endowment objectives 216 are bounded by endowment constraints 218 to limit grants to curing cancer in children, then the endowment request is disqualified.

Once an endowment request is automatically qualified, it is transitioned to the endowment authorization life cycle phase 208 for authorization. The endowment authorization life cycle phase 208 is likewise bounded by endowment constraints 218. As an example, endowment constraints 218 may specify that qualified endowment requests that are under a predetermined financial level can be automatically authorized, whereas those that are not require human authorization. In one embodiment, if the qualified endowment request is within endowment constraints 218 and meets other predetermined authorization criteria, it is automatically authorized by endowment life cycle administration system 202. In another embodiment, a qualified endowment request that is within endowment constraints 218 and meets other predetermined authorization criteria is automatically routed to one or more internal personnel for review. Once reviewed, the qualified endowment request is either authorized or declined, and according to predetermined workflow and business rules, is routed to the next recipient. It will be apparent to those of skill in the art that the steps required to authorize a qualified endowment request may be few or many, simple or complex, and may also require remedial actions before the authorization life cycle phase 208 is completed.

After a qualified endowment request is authorized, it is transitioned to the endowment provisioning life cycle phase 210 for fulfillment. Provisioning of an authorized endowment request is accomplished by assigning or transferring endowment resources 220 to the requester of the authorized endowment. Endowment resources 220 may include, but are not limited to, financial resources (e.g., monetary funds, line of credit, etc.), physical assets (e.g., laboratory equipment, computers, etc.), personnel (e.g., internal endowment sponsors, research personnel, etc.) and physical facilities (e.g., laboratory space).

Provisioning of an authorized endowment request is bounded by endowment constraints 218 and endowment resources 220, which are also bound by endowment constraints 218. For example, the scheduled provisioning of financial funds for an authorized endowment request may be controlled by endowment constraints 218 that limit a maximum monetary amount to be disbursed within a predetermined time period. As another example, the provisioning of endowment resources 220 (e.g., laptop computers, networking equipment, etc.) may be limited by endowment constraints 218 to the number of requested endowment resources 220 that are available for provisioning. In yet another example, the provisioning of the same endowment resources 220 may be limited by endowment constraints 218 to not exceed a predetermined percentage of endowment resources 220 available for provisioning. Those of skill in the art will appreciate that the provisioning of an authorized endowment request with endowment resources 220 may be a one time event, a recurring event over a predetermined time intervals, or events that are a result of other predetermined events.

Once the initial provisioning of an authorized endowment request has been completed, it is transitioned to the endowment obligation life cycle phase 212. Endowment obligations are the results 222 (e.g., concluded research, reports delivered, studies completed, etc.) the endowment requestor delivers in exchange for the provision of the endowment. The endowment obligation life cycle phase 212 is bounded by the endowment results 222 and the endowment resources 220, which are in turn bounded by the endowment constraints 218. As an example, the endowment requestor may be obligated to provide detailed reports every 90 days over a two year period in exchange for the provision of an endowment for studying the health effects of providing nutritional supplements to underprivileged children ages three to five. However, results 222 may not meet the original obligation of the provisioned endowment if resources 220 (e.g., monetary funding) are not made available as originally planned due to constraints 218 (e.g., cut backs in budgets for endowment funding). As a result, obligated endowment results 222 can be revised by the endowment life cycle administration system 202. Once endowment obligations have been fulfilled, the endowment is transitioned to the endowment termination life cycle phase 212. Final results are delivered and archived, and renewable or durable endowment resources 220 (e.g., assigned personnel, physical facilities, etc.) can be released for assignment to other endowments. The endowment is then signified as having reached the end of its life cycle.

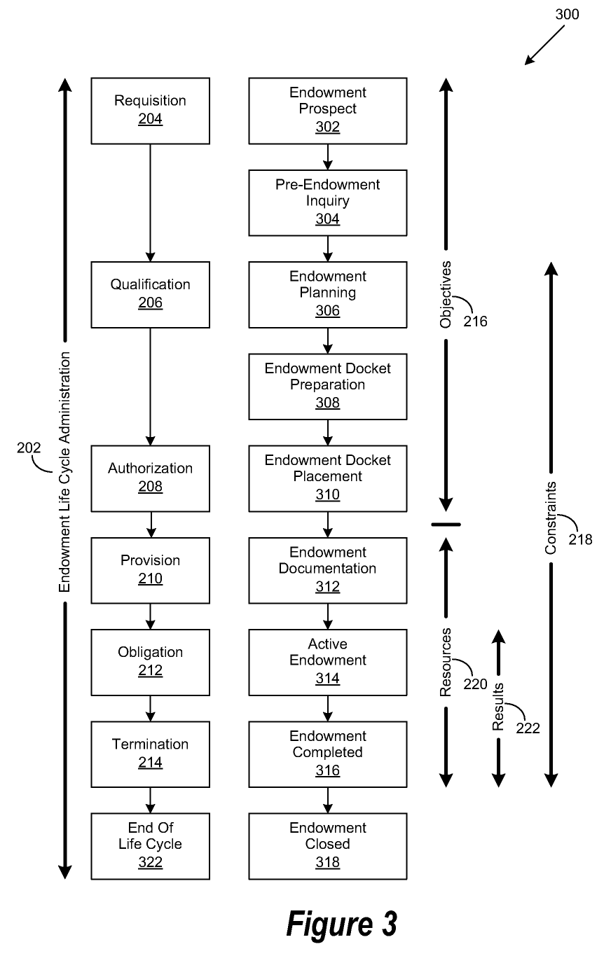

FIG. 3 is a simplified flow chart illustrating the life cycle phases 300 of an endowment as implemented in accordance with an embodiment of the invention. In this embodiment, an endowment request is automatically transitioned by the endowment life cycle administration system 202 through endowment life cycle phases of requisition 204, qualification 302, authorization 208, provision 210, obligation 212, termination 214, and end of life 322. These life cycle phases correspond to the steps generally implemented in the administration of an endowment request. For example, the requisition life cycle phase 204 corresponds to the endowment prospect step 302 and pre-endowment inquiry step 304. In the endowment prospect step 302, the endowment request is generally in its formative stages and may involve informal discussions or exchanges with prospective endowment requesters. Typically, initial research and feasibility analysis is conducted as well as how well the prospective endowment request may match endowment objectives 216. If there is a good fit between the prospective endowment and the endowment objectives 216, then the endowment requestor begins to provide endowment request information in pre-endowment inquiry step 304. The provided information may include documentation regarding the purpose of the prospective endowment request, requester background check information, legal and financial documentation, and other information required to transition the endowment request to the qualification life cycle phase 206.

The endowment qualification life cycle phase 206 corresponds to the endowment planning step 306 and the endowment docket preparation step 308. In the endowment planning step 306, additional research is conducted, endowment performance metrics are established, required endowment resources 220 are ascertained, and a prospective provisioning schedule is defined. Endowment objectives 216 are compared against endowment constraints 218, due diligence is completed, and any remaining endowment request details are submitted before the endowment request moves to the endowment docket preparation step 308. In this step, the endowment life cycle administration system 202 automatically gathers all endowment request information previously submitted and structures it into a predetermined format. The information is then made accessible for internal review. In one embodiment, the information is available for on-line retrieval, such as through Web pages. In another embodiment, the structured information is automatically routed, such as using a workflow application, to involved personnel for their review. Once the endowment request has passed initial internal review, it is transitioned to the endowment authorization life cycle phase 208, corresponding to the endowment docket placement step 310.

In the endowment docket placement step 310, the endowment request has completed its initial internal review and is ready to be authorized by one or more decision makers. In one embodiment, all information related to the endowment request, along with commentary from internal personnel, is available for on-line retrieval, such as through a Web site. In another embodiment, summary information and recommendations associated with the endowment request is automatically routed, such as through a workflow application, to one or more decision makers for approval. If approved, the endowment request is transitioned to the endowment provision life cycle phase 210, which corresponds to the endowment documentation step 312. In this step, endowment acceptance letters and provisioning schedules are created.

If the authorized endowment is accepted by its requester, provisioning of the authorized endowment request is accomplished by the assignment or transfer of endowment resources 220. As described in greater detail herein, endowment resources may include, but are not limited to, financial resources (e.g., monetary funds, line of credit, etc.), physical assets (e.g., laboratory equipment, computers, etc.), personnel (e.g., internal endowment sponsors, research personnel, etc.) and physical facilities (e.g., laboratory space). The provisioning of an authorized endowment request is contingent upon endowment constraints 218 and the availability of endowment resources 220, which are likewise bound by endowment constraints 218. It will be appreciated that the provisioning of an authorized endowment request with endowment resources 220 may be a one time event, a recurring event over a predetermined time intervals, or events that are a result of other predetermined events.

Once provisioning of an authorized endowment has commenced, the endowment is transitioned into the endowment obligation life cycle phase 212, corresponding to the active endowment step 314. In this step, endowment results 222 (e.g., concluded research, reports delivered, studies completed, etc.) are delivered by the endowment requestor in exchange for the provision of the endowment. Endowment results 222 are bounded by the endowment resources 220, which are in turn bounded by the endowment constraints 218.

As an example, the endowment requester may be obligated to provide detailed reports every 90 days over a two year period in exchange for the provision of an endowment. However, results 222 may not meet the original obligation of the provisioned endowment if resources 220 are not made available as originally planned due to constraints 218. Once endowment obligations have been fulfilled, the endowment is transitioned to the endowment termination life cycle phase 212, corresponding to the endowment completed step 316. Final results are delivered and archived, and renewable or durable endowment resources 220 (e.g., assigned personnel, physical facilities, etc.) can be released for assignment to other endowments. The endowment is then transitioned to the end of its life cycle, corresponding to the endowment closed step 318.

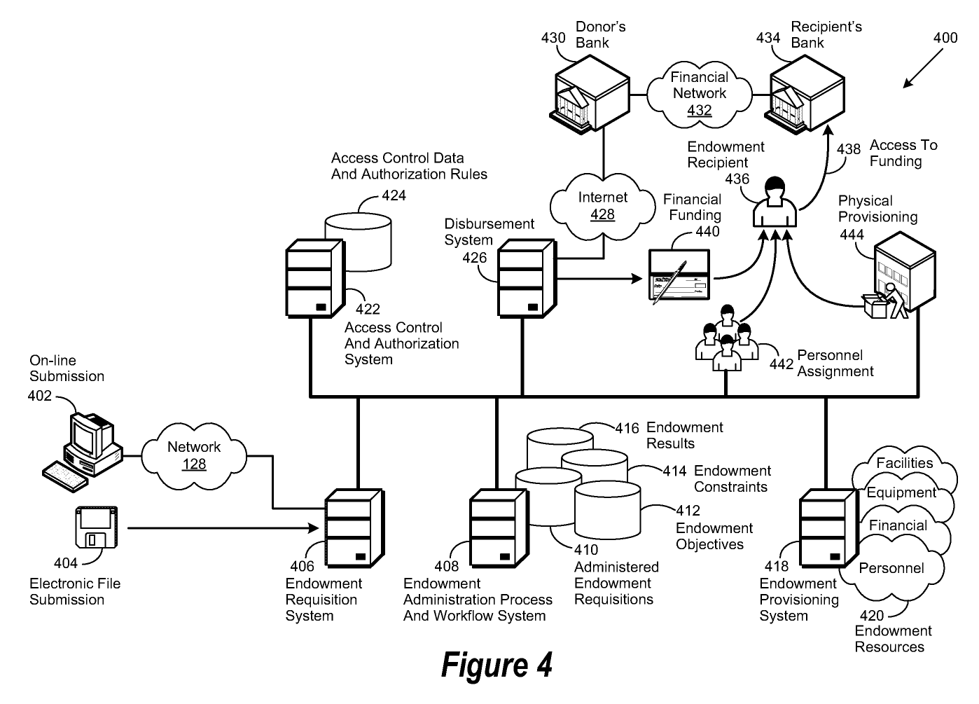

FIG. 4 is a generalized block diagram of an automated endowment life cycle administration system 400 as implemented in accordance with an embodiment of the invention. In various embodiments, the automated endowment life cycle administration system 400 comprises access control and authorization system 422, endowment requisition system 406, and endowment administrative process and workflow system 408. The automated endowment life cycle administration system 400 also comprises endowment provisioning system 418 and disbursement system 426 for the fulfillment of authorized endowments.

Access control and authorization system 422 comprises access control data and authorization rules 424 and is implemented to control access to information associated with an endowment throughout its life cycle. In one embodiment, access to endowment information is controlled by role-based authorization. For example, an endowment requestor may be granted access to endowment they have provided and the current approval status of their endowment request, but not be granted access to internal endowment reviews and other sensitive information. Similarly, an internal administrator may have access to the current financial disbursement status of an endowment, but not have access to internal financial information, such as current funds on hand.

The endowment administrative process and workflow system 408 comprises administered endowment requisitions 410, endowment objectives 412, endowment constraints 414, and endowment results 416. As described in greater detail herein, the endowment administrative process and workflow system 408 is responsible for the automated administration of an endowment throughout its life cycle. The endowment provisioning system 418 comprises endowment resources 420. Endowment resources 220 may include, but are not limited to, financial resources (e.g., monetary funds, line of credit, etc.), physical assets (e.g., laboratory equipment, computers, etc.), personnel (e.g., internal endowment sponsors, research personnel, etc.) and physical facilities (e.g., laboratory space).

In one embodiment, endowment requests (not shown) are submitted via on-line submission 402 through network 128 or via electronic file submission 404 to the endowment requisition system 406. As described in greater detail herein, the endowment administrative process and workflow system 408 manages the submitted endowment request throughout its life cycle phases of requisition, qualification, authorization, provision, obligation and termination. In the endowment provision life cycle phase, the endowment provisioning system 418 assigns or transfers endowment resources 220 to the requester of the authorized endowment. Financial resources are funded to the endowment recipient 436 through the disbursement system 426. In one embodiment, financial resources (e.g., monetary funds) are disbursed by originating an electronic funds transfer through the Internet 428. The electronic funds transfer instructions are received by the donor's bank 430, which in turn performs an electronic funds transfer through the financial network 432 to the endowment recipient's bank 434. Once the electronic transfer is complete, the endowment recipient 436 then has access 438 to the transferred financial resources. In another embodiment, the disbursement system 426 generates a physical financial funding 440 (e.g., a paper check), which is physically transferred to the endowment recipient 436. The endowment recipient 436 can then deposit the financial funding to their bank 434 for later access 438.

Physical endowment resources 420 (e.g., personnel 442, equipment, facilities, etc.) are similarly assigned or transferred to the endowment recipient 436 by the endowment provisioning system 418. In one embodiment, personnel assignments are generated and automatically routed to the assigned personnel 442. Assigned personnel may include, but are not limited to, internal administrators and sponsors, research personnel, or external contractors. In another embodiment, physical assets, such as computers or lab equipment, are physically provisioned 444 for transfer to the endowment recipient 436. It will be appreciated that the provisioning of an authorized endowment with endowment resources 420 may be a one time event, a recurring event over predetermined time intervals, or events that are a result of other predetermined events.

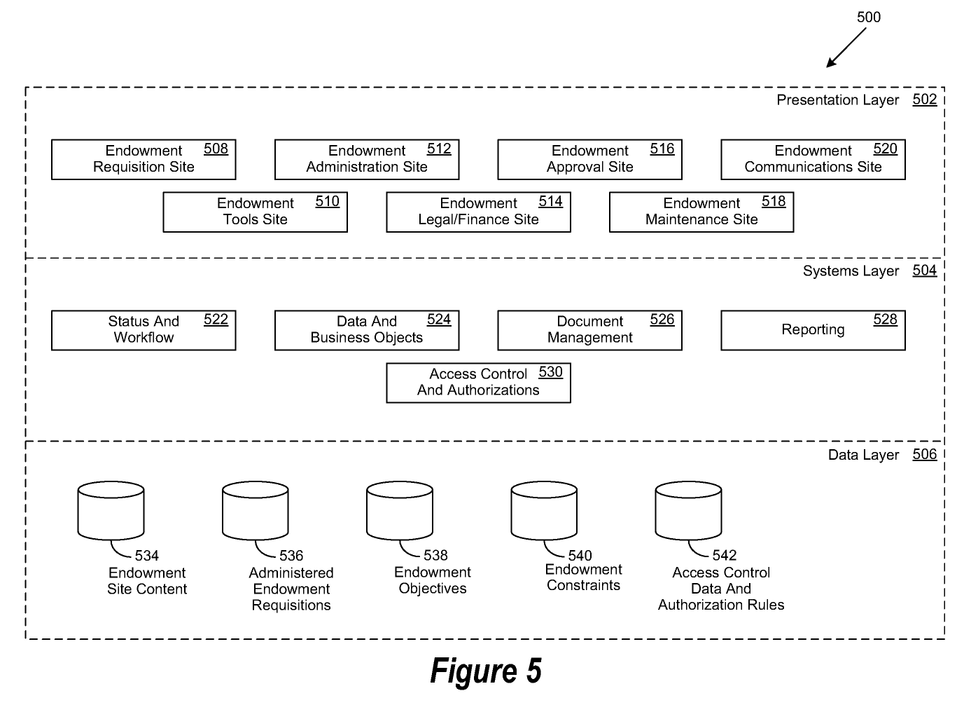

FIG. 5 is a simplified block diagram of the architecture of an automated endowment life cycle administration system 500 as implemented in accordance with an embodiment of the invention. In this and other embodiments, the automated endowment life cycle administration system 500 comprises a presentation layer 502, a systems layer 504, and a data layer 506. The presentation layer 502 comprises a plurality of Web sites, including the endowment requisition site 508, the endowment administration site 512, the endowment approval site 516, and the endowment communication site 520. The presentation layer 502 further comprises the endowment tools site, the endowment legal and financial site 514, and the endowment maintenance site 518. Skilled practitioners of the art will recognize that each of these Web sites may be wholly or individually hosted on one or multiple servers. Furthermore, the individual Web sites may share common pages, whose access is controlled by the access control and authorizations system 530 of systems layer 504.

The endowment requisition site 508 is the reception point for endowment requests and is typically used in the endowment requisition and endowment qualification life cycle phases as described in greater detail herein. The endowment administration site 512 is the administrator portal into the automated endowment life cycle administration system 500 and is used to administer other systems. As such, it is involved in all phases of an endowment's lifecycle administration. The endowment approval site 516 provides access to endowments that have been qualified and are ready for authorization. In one embodiment, decision makers access the endowment approval site 516 to view and authorize pending endowments that have been qualified. In another embodiment, decision makers receive an email with an embedded link to qualified endowments that are pending authorization.

The endowment communications site 520 provides access to the other Web sites that make up the presentation layer 502 and is used for creating, editing, and revising their Web pages. The endowment maintenance site 518 is used for system maintenance and administration of the systems that support Web sites that make up the presentation layer 502. The endowment tools site 510 comprises tools that assist prospective endowment requesters in preparing their endowment requests. The endowment legal and financial site comprises information and mechanisms used to ensure that endowments meet legal and financial guidelines. These guidelines may be internal, regulatory, or both.

The systems layer 504 comprises status and workflow system 522, data and business object system 524, document management system 526, reporting system 528, and access control and authorizations system 530. The status and workflow system 522 is used by the automated endowment life cycle administration system 500 to automatically manage an endowment throughout its life cycle phases. The data and business objects system 504 provide data management capabilities for the other systems that make up the system layer 504, whereas the document management system 526 is optimized for document management. The generation and management of reports, both internal and as a result of the endowment obligation life cycle phase, are managed by the reporting system 528. Access control and authorizations system 530 controls access to information associated with an endowment throughout its life cycle. In one embodiment, access to endowment information is controlled by role-based authorization as described in greater detail herein.

The data layer 506 comprises endowment site content 534, administered endowment requisitions 536, endowment objectives 538, endowment constraints 540, and access control data and authorization rules 542. The endowment site content 534 comprises content for the Web sites that make up presentation layer 502, and is accessed and managed through the endowment communications site 520. The administered endowment requisitions 536 comprise information associated with the administration of an endowment throughout its life cycle. This information is managed by the systems that make up systems layer 504, and is administered through the endowment administration site 512. Endowment objectives 538 and endowment constraints 540 comprise rules and other information that are used by the automated endowment life cycle administration system 500 to automatically manage an endowment throughout its life cycle phases. The access control data and authorization rules 542 comprise the information required by the access control and authorizations system 530 to ensure that only authorized personnel have access to endowment information throughout its life cycle.

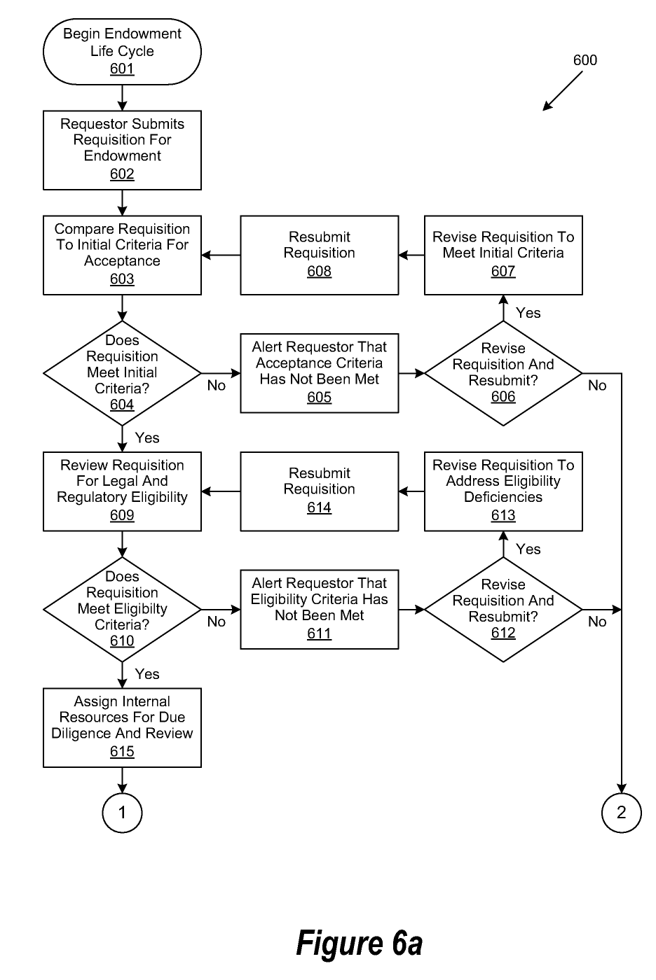

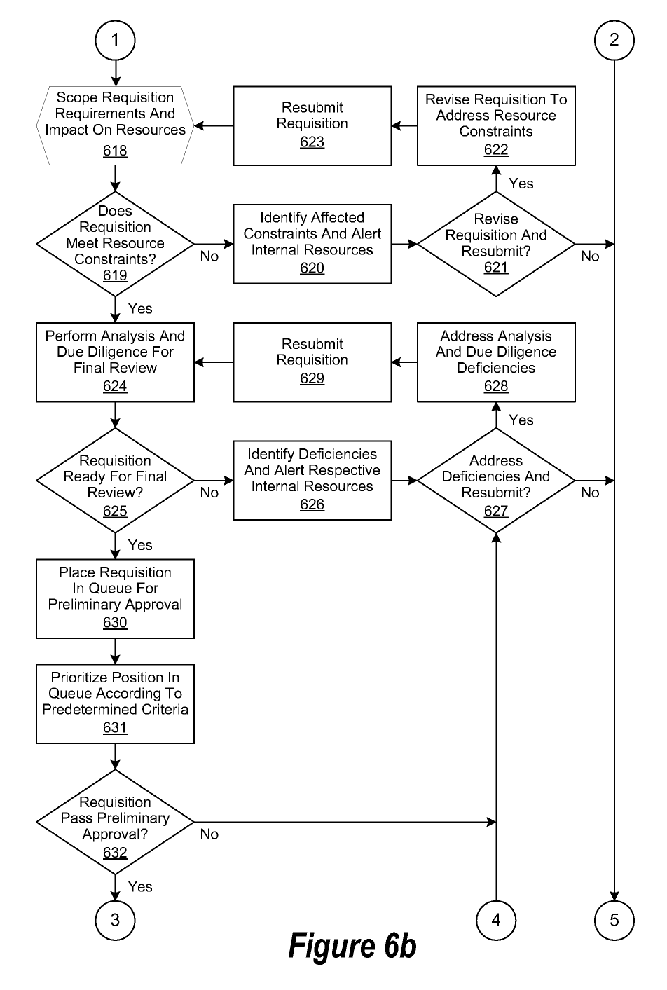

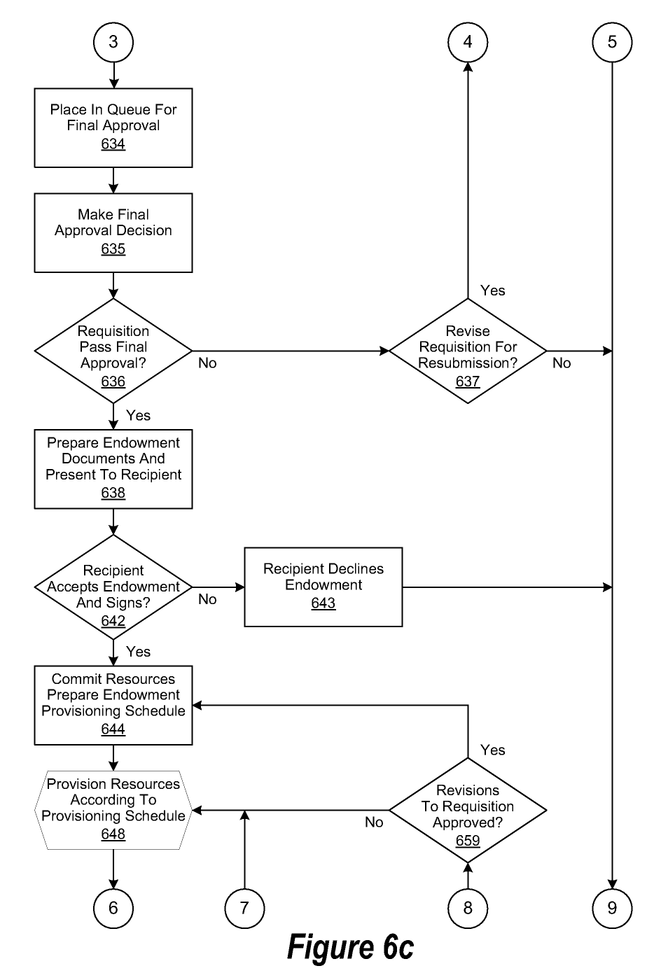

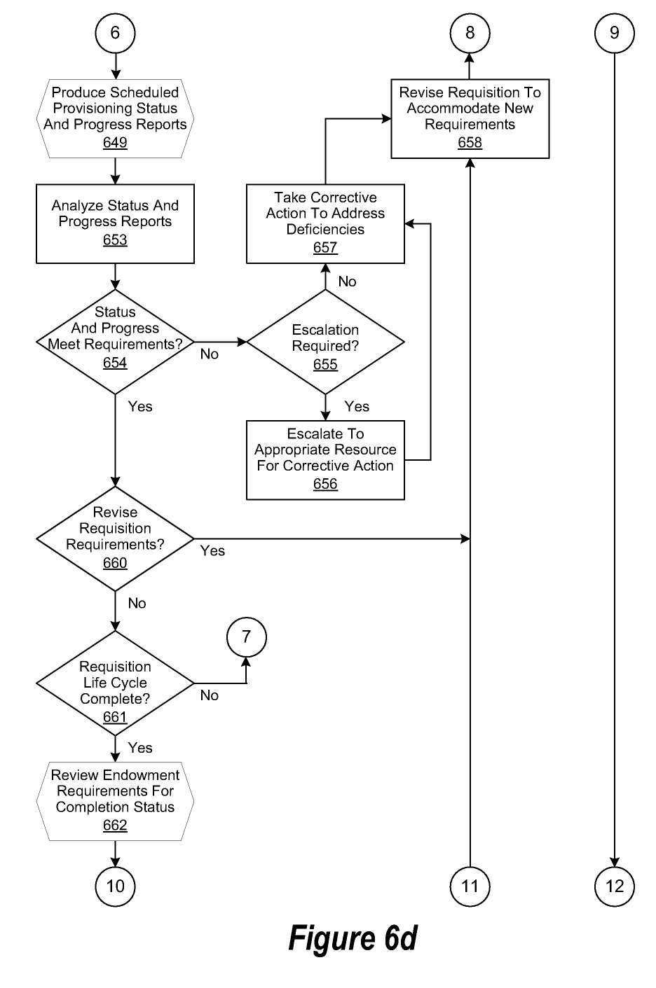

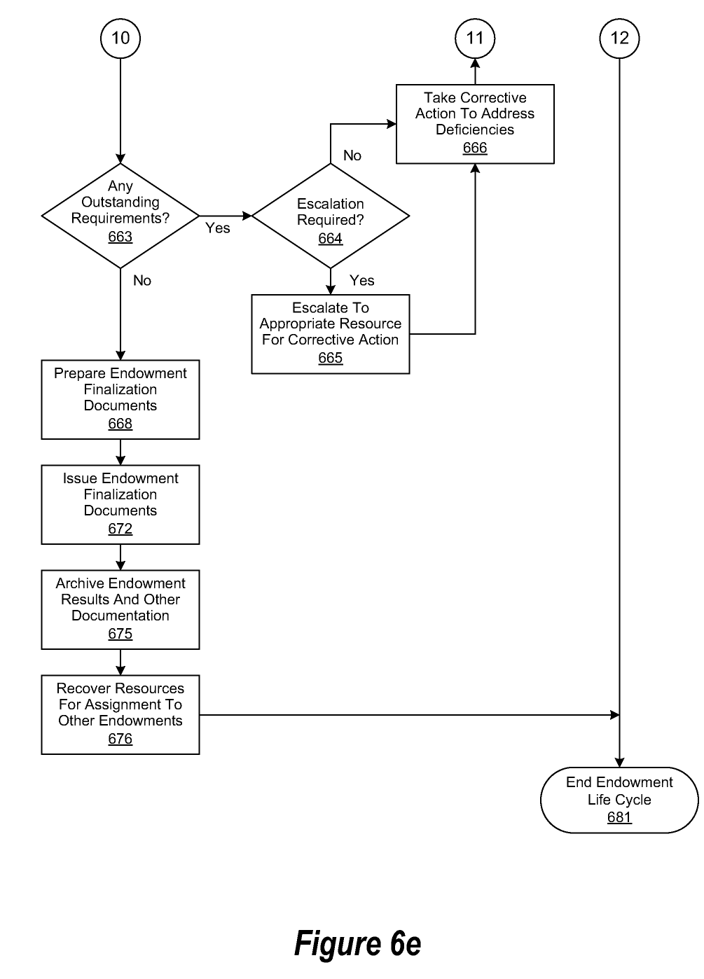

FIG. 6 is a generalized flow chart of the operation of an automated endowment life cycle management system 600 as implemented in accordance with an embodiment of the invention. In this embodiment, the life cycle of an endowment begins in step 602 with an endowment requestor submitting an endowment requisition in step 602. In one embodiment, the endowment requisition is submitted on-line via a network connection to the donor's endowment requisition site. In another embodiment, the endowment requisition is submitted via electronic file submission to the donor's endowment requisition system. In yet another embodiment, the submitted endowment requisition is for an initial endowment request, while in still another embodiment, the submitted endowment requisition is for a supplemental endowment requisition.

Once received, the submitted endowment requisition is compared in step 603 to the initial endowment acceptance criteria. If it is determined in step 604 that the submitted endowment requisition fails to meet the initial endowment acceptance criteria, then the endowment requestor is alerted in step 605 that the initial endowment acceptance criteria has not been met. If it is determined in step 606 that the endowment request is not to be revised and resubmitted, then the endowment life cycle ends in step 681. Otherwise, the endowment requisition is revised to meet the initial endowment acceptance criteria in step 607 and is then resubmitted in step 608. Upon resubmission, the process is repeated, beginning with step 603. In one embodiment, the automated endowment life cycle management system automatically communicates with the endowment requester and provides prompts and guidelines to assist in meeting the initial endowment acceptance criteria. In another embodiment, the automated endowment life cycle management system automatically communicates with the endowment requestor and internal personnel to facilitate meeting the initial endowment acceptance criteria. If it is determined in step 604 that the submitted endowment requisition meets the initial endowment acceptance criteria, then the process continues, beginning with step 609.

In step 609, the automated endowment life cycle management system automatically reviews the submitted requisition for legal and regulatory eligibility. If it is determined in step 610 that the submitted endowment requisition fails to meet the legal and regulatory eligibility criteria, then the endowment requester is alerted in step 611 that the legal and regulatory eligibility criteria has not been met. If it is determined in step 612 that the endowment request is not to be revised and resubmitted, then the endowment life cycle ends in step 681. Otherwise, the endowment requisition is revised to meet the legal and regulatory criteria in step 613 and is then resubmitted in step 614. Upon resubmission, the process is repeated, beginning with step 609. If it is determined in step 610 that the submitted endowment requisition meets the initial endowment acceptance criteria, then the process continues, beginning with step 615.

In step 615, internal resources are assigned to the endowment request for due diligence and review of the submitted endowment requisition. Once internal resources are assigned, the submitted endowment requisition is analyzed in step 618 for its requirements and the projected impact it would have on endowment resources. If it is determined in step 619 that the submitted endowment requisition fails to meet endowment resource constraints, then the endowment requester is alerted in step 620. In one embodiment, the endowment resource constraints that have been exceeded are automatically identified for the endowment requester. In another embodiment, the endowment requester is responsible for determining which endowment resource constraints have been exceeded. If it is determined in step 621 that the endowment request is not to be revised and resubmitted, then the endowment life cycle ends in step 681. Otherwise, the endowment requisition is revised to meet the endowment resource constraints in step 622 and is then resubmitted in step 623. Upon resubmission, the process is repeated, beginning with step 618. If it is determined in step 619 that the submitted endowment requisition meets the endowment resource constraints, then the process continues, beginning with step 624.

In step 624, the submitted endowment requisition is further analyzed by the automated endowment life cycle management system and due diligence for final review is performed. If it is determined in step 625 that the submitted endowment requisition is not ready for final review, then analysis and due deficiencies are automatically identified for internal resources in step 626. In one embodiment, the identified analysis and due diligence deficiencies are automatically routed to internal resources for resolution. In another embodiment, the internal resources are responsible for identifying the endowment request's analysis and due diligence deficiencies. If it is determined in step 627 that the endowment request is not to be revised and resubmitted, then the endowment life cycle ends in step 681. Otherwise, the endowment requisition is revised to address analysis and due diligence deficiencies in step 628 and is then resubmitted in step 629. Upon resubmission, the process is repeated, beginning with step 624. If it is determined in step 625 that the submitted endowment requisition is ready for final review, then the process continues, beginning with step 630.

In step 630, the endowment requisition is placed in a queue for preliminary approval and its priority in the queue is established in step 631. If it is determined in step 632 that the endowment requisition fails to pass preliminary approval, then it is determined in step 627 whether the deficiencies of the endowment will be addressed and resubmitted. If it is determined in step 627 to not address the deficiencies of the endowment requisition and resubmit, then the endowment life cycle ends in step 681. Otherwise, the process is repeated, beginning with step 628 by addressing the endowment requisition's analysis and due diligence deficiencies. If it is determined in step 632 that the endowment requisition passes preliminary approval, then the endowment requisition is placed in a queue for final approval in step 634 and a final approval decision is made in step 635. If it is determined in step 636 that the endowment requisition fails to pass final approval, then it is determined in step 637 whether the deficiencies of the endowment will be addressed and resubmitted. If it is determined in step 637 to not address the deficiencies of the endowment requisition and resubmit, then the endowment life cycle ends in step 681. Otherwise, the process is repeated, beginning with step 628 by addressing the endowment requisition's analysis and due diligence deficiencies. In one embodiment, if the endowment requisition fails to pass final approval in step 635, the endowment lifecycle automatically ends in step 681, and the endowment requestor has no recourse for resubmission. In another embodiment, if the endowment requisition fails to pass final approval in step 635, the endowment requestor is allowed to revise and resubmit their endowment requisition on an exception basis. If it is determined in step 636 that the endowment requisition passes final approval, then endowment documents are prepared and presented to the endowment recipient in step 638.

If it is determined in step 642 that the endowment recipient fails to accept and sign an endowment acceptance agreement, then the recipient declines the authorized endowment in step 643 and the endowment life cycle ends in step 681. Otherwise, endowment resources are committed and an endowment provisioning schedule is prepared in step 644. Provisioning of the committed endowment resources then begins in step 648 according to the provisioning schedule prepared in step 644. As described in greater detail herein, endowment resources may include, but are not limited to, financial resources (e.g., monetary funds, line of credit, etc.) and physical assets (e.g., laboratory equipment, computers, etc.). Similarly, endowment resources can also comprise personnel (e.g., internal endowment sponsors, research personnel, etc.) and physical facilities (e.g., laboratory space). As endowment resources are provisioned in step 648, endowment provisioning, progress, and status reports are generated in step 649.

These reports are analyzed by the automated endowment life cycle management system in step 653. It is then determined in step 654 whether the endowment provisioning, progress and status of the endowment meets the provisioning and obligations requirements of the endowment. If they do not, then it is determined in step 655 whether resolution of the identified endowment issues requires escalation. If it is determined that escalation is required, the automated endowment life cycle management system escalates the issues to the appropriate endowment resource (e.g., an administrator) for corrective action in step 656. Corrective action to address deficiencies in the endowment's performance are performed in step 657, and the endowment is revised in step 658 to accommodate the new requirements. If the revisions to the endowment are not approved in step 659, the process is repeated, beginning with step 648 with the provisioning of resources according to the existing provisioning schedule. If the revisions to the endowment are approved, the process is repeated, beginning with step 644 with the revisions to the commitment of endowment resources and the associated provisioning schedule in step 644. If it is determined in step 655 that escalation is not required, then corrective action to address deficiencies in the endowment's performance are performed in step 657, and the process is repeated, beginning with step 658.

If it is determined in step 654 that the endowment provisioning, progress and status of the endowment meets the provisioning and obligations requirements of the endowment, then it is determined in step 660 whether the endowment requisition requires revision. If it is determined in step 660 that the endowment requisition requires revisions, then the endowment requisition is revised in step 658 to accommodate the new requirements and the process is repeated, beginning with step 659. Otherwise, it is then determined in step 661 whether the endowment requisition lifecycle is complete. If it is not, then the process is repeated, beginning with step 648 with the provisioning of endowment resources according to the pre-existing provisioning schedule. If it is determined in step 662 that the endowment requisition life cycle is complete, then the completion status of the provisioning and obligation requirements for the endowment are reviewed in step 662.

If it is determined in step 663 that provisioning and obligation requirements remain outstanding for the endowment, then it is determined in step 664 whether resolution of the identified endowment issues requires escalation. If it is determined that escalation is required, the automated endowment life cycle management system escalates the issues to the appropriate endowment resource (e.g., an administrator) for corrective action in step 665. Corrective action to address deficiencies in the endowment's performance are performed in step 666, and the endowment is revised in step 658 to accommodate the new requirements. If the revisions to the endowment are not approved, the process is repeated, beginning with step 648 with the provisioning of resources according to the existing provisioning schedule. If the revisions to the endowment are approved, the process is repeated, beginning with step 644 with the revisions to the commitment of endowment resources and the associated provisioning schedule in step 644. If it is determined in step 664 that escalation is not required, then corrective action to address deficiencies in the endowment's performance are performed in step 666, and the process is repeated, beginning with step 658.

Otherwise, endowment finalization papers are prepared in step 668, and they are issued to all involved endowment stakeholders in step 672. The results of the endowment and other associated documentation are archived in step 675 and any recoverable endowment resources are released for assignment to other endowments in step 676. For example, research personnel may have been assigned to the completed endowment and are now available for reassignment. As another example, facility space that was made available to the completed endowment can likewise be made available to other endowments. Once these and other associated endowment processes are concluded, the endowment reaches the end of its life cycle in step 681.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, it will be appreciated that other types of endowments in addition to grants and scholarships are within the scope of the invention. Generally, an endowment provider provides resources for the support or maintenance of an endowment recipient. For example with a grant type endowment, the endowment provider is the grantor and the endowment recipient is the grantee.

Consequently, the invention is intended to be limited only by the spirit and scope of the appended claims, giving full cognizance to equivalents in all respects.

What is claimed is:

1. A computer-implementable method for the automated administration of an endowment, comprising:
generating a plurality of endowment administration metrics; and
using said administration metrics to administer an endowment throughout a life cycle of the endowment, wherein the life cycle comprises a plurality of life cycle phases.

2. The method of claim 1, wherein said endowment administration metrics further comprise:
at least one endowment constraint;
at least one endowment objective, said endowment objective bounded by said at least one endowment constraint;
a plurality of endowment resources, said endowment resources bounded by said at least one endowment constraint; and
at least one endowment result.

3. The method of claim 2, wherein said life cycle phases comprise receiving at least one request for an endowment in an electronic format, said endowment requisition comprising a plurality of endowment requisition data; the method further comprising: enabling validation of said endowment requisition data by a plurality of endowment request validation criteria.

4. The method of claim 2, wherein said life cycle phases comprise qualifying at least one received endowment requisition with a plurality of endowment qualification criteria and wherein said plurality of endowment qualification criteria are bounded by:
said at least one endowment constraint; and
said at least one endowment objective, said at least one endowment objective further bounded by said at least one predetermined endowment constraint.

5. The method of claim 2, wherein said life cycle phases comprise authorizing at least one qualified endowment requisition and wherein said endowment authorization is bounded by said at least one endowment constraint.

6. The method of claim 2, wherein said life cycle phases comprise provisioning at least one authorized endowment requisition and wherein said endowment provision is bounded by:
said at least one endowment constraint; and
said plurality of predetermined endowment resources, wherein said plurality of predetermined endowment resources are further bounded by said at least one predetermined endowment constraint and are available for provision.

7. The method of claim 1, wherein said life cycle phases comprise obligating at least one provisioned endowment, wherein said endowment obligation is bounded by:
said plurality of endowment resources, wherein said plurality of endowment resources are available for obligation; and
said at least one endowment result, wherein said at least one endowment result is further bounded by said plurality of endowment resources and comprises endowment result criteria.

8. The method of claim 1, wherein said life cycle phases comprise terminating at least one obligated endowment, wherein said endowment termination is bounded by the completion of said at least one endowment result, said at least one endowment result further bounded by said plurality of endowment resources.

9. An automated endowment administration system comprising:
a processor;
a data bus coupled to the processor; and
a computer-usable medium embodying computer program code, said computer-usable medium being coupled to the data bus, the computer program code interacting with a plurality of computer operations and comprising instructions executable by the processor and configured for:
generating a plurality of endowment administration metrics; and
using said administration metrics to administer an endowment throughout a life cycle of the endowment, wherein the life cycle comprises a plurality of life cycle phases.

10. The system of claim 9, wherein said endowment administration metrics further comprise:
at least one endowment constraint;
at least one endowment objective, said endowment objective bounded by said at least one endowment constraint;
a plurality of endowment resources, said endowment resources bounded by said at least one endowment constraint; and
at least one endowment result.

11. The automated endowment administration system of claim 10, wherein said life cycle phases comprise receiving at least one request for an endowment in an electronic format, said endowment requisition comprising a plurality of endowment requisition data; and the computer code further comprises instructions executable by the processor and configured for enabling validation of said endowment requisition data by a plurality of endowment request validation criteria.

12. The automated endowment administration system of claim 10, wherein said life cycle phases comprise qualifying at least one received endowment requisition with a plurality of endowment qualification criteria, said plurality of endowment qualification criteria bounded by:
said at least one endowment constraint; and
said at least one endowment objective, said at least one endowment objective further bounded by said at least one endowment constraint.

13. The automated endowment administration system of claim 10, wherein said life cycle phases comprise authorizing at least one qualified endowment requisition, said endowment authorization bounded by said at least one endowment constraint.

14. The automated endowment administration system of claim 10, wherein said life cycle phases comprise provisioning at least one authorized endowment requisition, said endowment provision bounded by:
said at least one endowment constraint; and
said plurality of endowment resources, wherein said plurality of endowment resources are further bounded by said at least one endowment constraint and available for provision.

15. The automated endowment administration system of claim 10, wherein said life cycle phases comprise obligating at least one provisioned endowment, said endowment obligation bounded by:
said plurality of endowment resources, wherein said plurality of endowment resources are available for obligation; and
said at least one endowment result, wherein said at least one endowment result is further bounded by said plurality of endowment resources and comprises endowment result criteria administered.

16. The automated endowment administration system of claim 10, wherein said life cycle phases comprise terminating at least one obligated endowment, said endowment termination bounded by the completion of said at least one endowment result, said at least one endowment result further bounded by said plurality of endowment resources.

17. A computer-usable medium embodying computer program code, the computer program code comprising computer executable instructions configured for:
generating a plurality of endowment administration metrics; and
using said administration metrics to administer an endowment throughout a life cycle of the endowment, wherein the life cycle comprises a plurality of life cycle phases.

18. The method of claim 17, wherein said endowment administration metrics further comprise:
at least one endowment constraint;
at least one endowment objective, said endowment objective bounded by said at least one endowment constraint;
a plurality of endowment resources, said endowment resources bounded by said at least one endowment constraint; and
at least one endowment result.

19. The computer usable medium of claim 18, wherein said life cycle phases comprise receiving at least one request for an endowment in a electronic format, said endowment requisition comprising a plurality of endowment requisition data; and wherein said computer code is operable to enable validation of said endowment requisition data by a plurality of endowment request validation criteria.

20. The computer usable medium of claim 18, wherein said life cycle phases comprise qualifying at least one received endowment requisition with a plurality of endowment qualification criteria, said plurality of endowment qualification criteria bounded by:
said at least one endowment constraint; and
said at least one endowment objective, said at least one endowment objective further bounded by said at least one endowment constraint.

21. The computer usable medium of claim 18, wherein said life cycle phases comprise authorizing at least one qualified endowment requisition and wherein said endowment authorization is bounded by said at least one endowment constraint.

22. The computer usable medium of claim 18, wherein said life cycle phases comprise provisioning at least one authorized endowment requisition, said endowment provision is configurable to be bounded by:
said at least one endowment constraint; and
said plurality of predetermined endowment resources, wherein said plurality of predetermined endowment resources are further bounded by said at least one predetermined endowment constraint and are available for provision.

23. The computer usable medium of claim 18, wherein said life cycle phases comprise obligating at least one provisioned endowment, said endowment obligation is bounded by:
said plurality of endowment resources, wherein said plurality of endowment resources are available for obligation; and
said at least one endowment result, wherein said at least one endowment result is further bounded by said plurality of endowment resources and comprises endowment result criteria.

24. The computer usable medium of claim 18, wherein said life cycle phases comprise terminating at least one obligated endowment, wherein said endowment termination is bounded by the completion of said at least one endowment result, said at least one endowment result further bounded by said plurality of endowment resources.

25. The computer usable medium of claim 18, wherein said computer executable instructions are deployable to a client computer from a server at a remote location.

26. The computer usable medium of claim 18, wherein said computer executable instructions are provided as a software service to a client computer on an on-demand basis.
